(19) United States
(12) Patent Application Publication
(10) Pub. No.: US 2009/0322663 A1
(43) Pub. Date: Dec. 31, 2009

(54) DISPLAY DEVICE

(75) Inventors: Masaki Nose, Kawasaki (JP); Tomohisa Shingai, Kawasaki (JP); Hirokata Uehara, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/408,874

(22) Filed: Mar. 23, 2009

(30) Foreign Application Priority Data
Jun. 25, 2008 (JP) 2008-166126

(51) Int. Cl. G09G 3/36

(52) U.S. Cl. 345/89

(57) ABSTRACT

A display device with low power consumption capable of canceling the collapse of gradation and skip of gradation in a high gradation part and a low gradation part and of displaying an even gradation in a wide range has been disclosed. The display device comprises a display element of dot matrix type having a display material with memory properties, a drive circuit that drives a pixel of the display element, and a control circuit that controls the drive circuit, wherein the control circuit executes an initialization step for applying a voltage pulse to initialize a pixel to be rewritten to bring the pixel into an initialization state and a gradation step for applying a voltage pulse to change the gradation state of a pixel, and in the gradation step, an alternating voltage pulse is formed in a pixel to be rewritten and the period and voltage of the alternating voltage pulse are varied in accordance with a gradation to be written.

### CROSS-REFERENCE TO RELATED APPLICATION

This application is based upon and claims the benefit of priority of the prior Japanese Patent Application No. 2008-166126, filed on Jun. 25, 2008, the entire contents of which are incorporated herein by reference.

### FIELD

The embodiments discussed herein are related to a display device.

### BACKGROUND

Recently, the development of electronic paper has been positively promoted in companies, universities, etc. As application fields where the utilization of electronic paper is expected, there have been proposed a variety of forms, such as electronic books, sub-displays of mobile terminal equipment, display parts of IC cards. One type of electronic paper is a display using a cholesteric liquid crystal. A cholesteric liquid crystal has excellent characteristics, such as semipermanent display maintenance (memory properties), vivid color display, high contrast, and high resolution.

A cholesteric liquid crystal is sometimes referred to as a chiral nematic liquid crystal, and is a liquid crystal in which the molecules of the nematic liquid crystal form a helical cholesteric phase by adding a comparatively large amount (tens of percents) of chiral additives (chiral materials) to the nematic liquid crystal.

FIG. 1A and FIG. 1B are diagrams illustrating the state of the cholesteric liquid crystal. As illustrated in FIG. 1A and FIG. 1B, a display element 10 that utilizes the cholesteric liquid crystal has an upper side substrate 11, a cholesteric liquid crystal layer 12, and a lower side substrate 13. The cholesteric liquid crystal has a planar state in which incident light is reflected as illustrated in FIG. 1A and a focal conic state in which incident light passes through as illustrated in FIG. 1B, and these states are kept stable even under no electric field.

In the planar state, light having a wavelength in accordance with the helical pitch of liquid crystal molecules is reflected. A wavelength λ with which the reflection is maximum is expressed by the following expression

λ=n·p

where n denotes the average refractive index of the liquid crystal and p denotes the helical pitch.

On the other hand, a reflection band Δλ differs depending on the refractive index anisotropy λn of the liquid crystal.

In the planar state, incident light is reflected, and therefore, a “bright” state, i.e., white can be expressed. On the other hand, in the focal conic state, light having passed through the liquid crystal layer is absorbed by a light absorption layer provided under lower side substrate 13, and therefore, the “dark” state, i.e., black can be expressed.

Next, a drive method of a display element that utilizes the cholesteric liquid crystal will be explained.

FIG. 2 illustrates an example of the general voltage-reflection characteristic of the cholesteric liquid crystal. The horizontal axis represents the voltage value (V) of a pulse voltage to be applied with a given pulse width between electrodes that sandwich the cholesteric liquid crystal and the vertical axis represents the reflectance (%) of the cholesteric liquid crystal. A solid curved line P illustrated in FIG. 2 represents the voltage-reflectance characteristic of the cholesteric liquid crystal when the initial state is the planar state and a broken curved line FC represents the voltage-reflectance characteristic of the cholesteric liquid crystal when the initial state is the focal conic state.

In FIG. 2, if a given high-voltage VP100 (for example, ±36 V) is applied between electrodes to generate a relatively strong electric field in the cholesteric liquid crystal, the helical structure of the liquid crystal molecules is completely untied and a homeotropic state is brought about where all the molecules line up in the direction of the electric field. Next, when the liquid crystal molecules are in the homeotropic state, if the applied voltage is rapidly reduced to a given low-voltage (for example, VF=±4 V) from VP100 to rapidly reduce the electric field in the liquid crystal to about zero, the helical axis of the liquid crystal becomes perpendicular to the electrode and the planar state is brought about where light is reflected selectively in accordance with the helical pitch.

On the other hand, if a given low-voltage VF100b (for example, ±24 V) is applied between electrodes to generate a relatively weak electric field in the cholesteric liquid crystal, a state is brought about where the helical structure of the liquid crystal molecules is not completely untied. In this state, if the applied voltage is rapidly reduced to low-voltage VF0 from FV100b to rapidly reduce the electric field in the liquid crystal to about zero, or if a strong electric field is applied and then the electric field is gradually removed, the helical axis of the liquid crystal molecules becomes parallel to the electrode and the focal conic state is brought about where incident light passes through.

If an electric field of intermediate strength is applied and then the electric field is rapidly removed, the planar state and the focal conic stage coexist mixedly and the display of an intermediate gradation is available.

Along curved line P illustrated in FIG. 2, in an area “A” surrounded by a broken line, the ratio of the focal conic state is increased with increasing voltage value of the voltage pulse to be applied and thus the reflectance of the cholesteric liquid crystal can be reduced. Further, along curved lines P and FC illustrated in FIG. 2, in an area “B” surrounded by a broken line, the ratio is increased with increasing voltage value to be applied and thus the reflectance of the cholesteric liquid crystal can be reduced.

In order to display an intermediate gradation, “A” area or “B” area is utilized. When “A” area is utilized, after the pixel is initialized to bring it into the planar state, a voltage pulse between VF0 and VF100a is applied and thus the focal conic state is partially brought about. When “B” area is utilized, after the pixel is initialized to bring it into the focal conic state, a voltage pulse between VF100b and VP0 is applied and thus the planar state is partially brought about.

The principles of drive method based on the voltage response characteristic explained above are explained with reference to FIG. 3A, FIG. 3B, and FIG. 4A to FIG. 4D. FIG. 3A, FIG. 4A, and FIG. 4C illustrate waveforms of voltage pulses. FIG. 3B, FIG. 4B, and FIG. 4D illustrate the pulse response characteristics when the voltage pulses in FIG. 3A, FIG. 4A, and FIG. 4C are applied, respectively. FIG. 3A illustrates a voltage pulse with a voltage value of ±36 V and a pulse width of tens of milliseconds. FIG. 4A illustrates a voltage pulse with an ON-time voltage value of ±20 V, an OFF-time voltage value of ±10 V, and a pulse width of 2 ms. FIG. 4C illustrates a voltage pulse with an ON-time voltage value of ±20 V, an OFF-time voltage value of ±10 V, and a pulse width of 1 ms. In FIG. 3B, FIG. 4B, and FIG. 4D, the horizontal axis represents the voltage (V) and the vertical axis represents the reflectance (%). The voltage-reflectance characteristic in FIG. 3B is illustrated by schematizing curved lines P and FC in FIG. 2 and the voltage-reflectance characteristic in FIG. 4B and FIG. 4D is illustrated by schematizing only curved line P in FIG. 2. The voltage pulse used here is a combination of a positive polarity pulse and a negative polarity pulse in order to prevent deterioration of the liquid crystal due to ion polarization as well known as a drive pulse of a liquid crystal.

As illustrated in FIG. 3A and FIG. 3B, when the pulse width is large, if the initial state is the planar state and the voltage is raised to a certain range, the focal conic state is brought about and if the voltage is further raised, the planar state is brought about again. When the initial state is the focal conic state, as the pulse voltage is raised, the state becomes more and more like the planar state.

When the pulse width is large, the pulse voltage that leads to the planar state without exception regardless that the initial state is the planar state or the focal conic state is ±36 V in FIG. 3B. This intermediate pulse voltage brings about a state where the planar state and the focal conic state coexist mixedly and thus an intermediate gradation can be obtained.

On the other hand, when the pulse width is 2 ms as illustrated in FIG. 4A and FIG. 4B, if the initial state is the planar state, the reflectance does not change for a pulse voltage of ±10 V; however, for a larger voltage, a state is brought about where the planar state and the focal conic state coexist mixedly and thus the reflectance reduces. The amount of reduction in reflectance increases with the increasing voltage, however, for a voltage higher than ±36 V, the amount of reduction in reflectance will be constant. This also applies to the state where the initial state is a state where the planar state and the focal conic state coexist mixedly. Consequently, when the initial state is the planar state, if a voltage pulse with a pulse width of 2 ms and a pulse voltage of ±20 V is applied once, the reflectance is reduced by a certain amount. In this manner, in a state where the planar state and the focal conic state coexist mixedly and the reflectance is reduced a little, if a voltage pulse with a pulse width of 2 ms and a pulse voltage of ±20 V is further applied, the reflectance further reduces. By repeating this, the reflectance reduces to a given value.

As illustrated in FIG. 4C and FIG. 4D, when the pulse width is 1 ms, the application of the voltage pulse will reduce the reflectance as in the case where the pulse width is 2 ms; however, the amount of reduction in reflectance is smaller than when the pulse width is 2 ms.

From the above, it can be understood that if a pulse with a pulse width of tens of milliseconds and a voltage of 36 V is applied, the planar state is brought about, if a pulse with a pulse width of about 2 ms and a voltage of about from ten something to 20 V is applied, the state is brought about from the planar state into a state where the planar state and the focal conic state coexist mixedly and thus the reflectance is reduced, and the amount of reduction in reflectance depends on the cumulative time of the pulse.

Because of this, in the cholesteric liquid crystal display device, an initialization pulse with a pulse width of tens of milliseconds and a voltage of ±36 V is applied to a pixel to be rewritten to bring the pixel into the planar state in the first step and in the next second step, a gradation pulse with a narrow pulse width and a voltage about ±20 V is applied to a pixel to be turned into an intermediate gradation, and the cumulative application time is set to a value corresponding to the level of the intermediate gradation. In other words, in this display method, area A in FIG. 2 is utilized to display an intermediate gradation level.

In the display device, a plurality of scan electrodes parallel to each another is provided on one surface of a display material layer, a plurality of data electrodes parallel to each another intersecting with the plurality of scan electrodes is provided on the other surface of the display material layer, and thus a pixel is formed at the intersection of the scan electrode and the data electrode. The scan electrode is referred to as a scan line and the data electrode is referred to as a data line. In the display device, a common driver applies a scan pulse to the scan line and a segment driver applies a data pulse to the data line.

In the first step, pulses are applied simultaneously to all of the scan lines and all of the data lines. In the second step, in order to set a gradation level for each pixel, data pulses are applied to all of the data lines while a scan pulse is being applied to one scan line, and thereby, a voltage pulse is applied to the pixels in the one scan line. After that, by sequentially shifting the scan line to which the scan pulse is applied, the application of the voltage pulse to the pixels in all of the scan lines is completed.

In the second step, while a selection scan voltage corresponding to the scan pulse is applied to one scan line, a non-selection scan voltage is applied to the other scan lines. To the data line of the pixel to which a gradation is written, a selection data voltage corresponding to the data pulse is applied and a non-selection voltage is applied to the data line of the pixel to which no gradation is written. Consequently, the pixels to which the selection scan voltage and the selection data voltage have been applied, the pixels to which the non-selection scan voltage and the selection data voltage have been applied, the pixels to which the non-selection scan voltage and the selection data voltage have been applied, and the pixels to which the non-selection scan voltage and the non-selection data voltage have been applied exist as a result. It is necessary to set the selection scan voltage, the non-selection scan voltage, the selection data voltage, and the non-selection data voltage so that the reflectance (gradation) is reduced only at the pixels to which the selection scan voltage and the selection data voltage have been applied and the reflectance (gradation) is not reduced at the three other kinds of pixel.

In the display device that utilizes the cholesteric liquid crystal, the segment driver and the common driver output, for example, such a pulse as illustrated in FIG. 5A, as a gradation pulse to be applied to change the planar state into an intermediate gradation level. By the application of such a pulse, such a voltage as illustrated in FIG. 5B is applied to the pixel.

To the segment driver, 20 V is supplied as V0 and 10 V as V21S and V34S, and a positive pulse is output in the positive polarity phase (FR=1) and a negative pulse is output in the negative polarity phase (FR=0).

To the common driver, 20 V is supplied as V0, 15 V as V21C, and 5 V as V34C, and a negative pulse is output in the positive polarity phase (FR=1) and a positive pulse is output in the negative polarity phase (FR=0).

By the application of such a pulse as illustrated in FIG. 5A, when the scan line is in the selection state (the common driver is ON) and the data line is also in the selection state (the segment driver is ON), 20 V is applied in the positive polarity phase (FR=1) and −20 V is applied in the negative phase (FR=0). When the scan line is in the selection state (the common driver is ON) and the data line is in the non-selection state (the segment driver is OFF), 10 V is applied in the positive polarity phase (FR=1) and −10 V is applied in the negative polarity phase (FR=0). When the scan line is in the non-selection state (the common driver is OFF) and the data line is in the selection state (the segment driver is ON), 5 V is applied in the positive polarity phase (FR=1) and −5 V is applied in the negative phase (FR=0). When the scan line is in the non-selection state (the common driver is OFF) and the data line is in the non-selection state (the segment driver is OFF), −5 V is applied in the positive polarity phase (FR=1) and 5 V is applied in the negative phase (FR=0).

Consequently, the waveform of the voltage pulse to be applied to each pixel of the scan line in the selection state will be as illustrated in FIG. 6A and the waveform of the voltage pulse to be applied to each pixel of the scan line in the non-selection state will be as illustrated in FIG. 6B, and in both cases, the waveform of the data line in the selection state is illustrated by the solid line and the waveform of the data line in the non-selection state is illustrated by the dotted line. As illustrated in FIG. 4B, in the case of the voltage pulse with a pulse width of 2 ms, the state of the liquid crystal changes, that is, the reflectance changes, when the voltage is ±20 V; however, the reflectance does not change when the voltage is ±10 V, and therefore, with the waveform as described above, when both the scan line and the data line are ON, writing by the gradation pulse is carried out and writing is not carried out in other cases. In actuality, there is a case where the influence of the crosstalk is taken into consideration; however, it does not relate to the embodiments directly, and therefore, its explanation is omitted.

As describe above, the voltage pulse to be applied actually in the display device has the waveform as illustrated in FIG. 6; however, there is a case where it is illustrated by a positive/negative pulse symmetric with respect to 0 V as its center for the simplification of the explanation in the following description. In addition, the voltage of the OFF pulse is assumed to be set to a level at which writing is not carried out and the voltage of the pulse is assumed to indicate the voltage of the ON pulse.

For the multi-gradation display methods of the cholesteric liquid crystal, various drive methods have been proposed. The drive methods of multi-gradation display of the cholesteric liquid crystal are divided into two methods, i.e., the dynamic drive method and the conventional drive method.

Japanese Laid-open Patent Publication (Kokai) No. 2001-228459 discloses the dynamic drive method. However, the dynamic drive method has a problem that its manufacturing cost is increased because the drive waveforms are complicated, and therefore, the complicated control circuit and the driver IC are required, and the transparent electrode of the panel with a low resistance is required. In addition, the dynamic drive method also has a problem that power consumption is large.

Document Y. -M Zhu, D -K. Yang, Cumulative Drive Schemes for Bistable Reflective Cholesteric LCDs, SID 98 DIGEST, pp 798-801, 1998 discloses the conventional drive method. This document describes a method of gradually driving from the planar state into the focal conic state or driving at a comparatively high speed of semi-moving picture rate from the focal conic state into the planar state by utilizing the cumulative time inherent in the liquid crystal and adjusting the number of times of the application of short pulse.

When a gradation is set by utilizing the cumulative time in the conventional drive method, there are a method of adjusting the number of times of the application of short pulse and a method in which a pulse width W is varied. The method in which the pulse width is varied is more advantage than the method in which the number of times of the application of short pulse is adjusted in terms of the suppression of power consumption. Further, there is a method in which the cumulative time of the application of pulse is changed by both the pulse width and the number of application times. FIG. 7A to FIG. 7D are diagrams illustrating examples of voltage pulses in such methods, illustrating the voltage pulses and the gradation states that change by the application thereof. A writing method of setting a gradation by changing the pulse width of a voltage signal to be applied is referred to as a PWM method.

FIG. 7A illustrates an initialization pulse used in the first step, having a pulse voltage of ±36 V and a comparatively large pulse width. The application of the pulse brings the liquid crystal in the pixel into the planar state and the maximum gradation state. FIG. 7B to FIG. 7D illustrate first to third gradation pulses used in the second step and each has a pulse voltage of ±20 V, however, the pulse width becomes narrower in the order of the first to third gradation pulses. The application of the pulses in FIG. 7B to FIG. 7D brings part of the liquid crystal in the pixel from the planar state into the focal conic state and reduces the gradation and the degree of the reduction in gradation becomes smaller in the order from FIG. 7B to FIG. 7D. In other words, the application of the pulses in FIG. 7B to FIG. 7D produces a low gradation, an intermediate gradation, and a high gradation relatively. The pulse in FIG. 7B is referred to as a low gradation pulse, that in FIG. 7C as an intermediate gradation pulse, and that in FIG. 7D as a high gradation pulse. This means that only four gradations can be represented only by applying either of the pulses in FIG. 7B to FIG. 7D or not applying any, however, it is also possible to combine the three kinds of pulse illustrated in FIG. 7B to FIG. 7D. For example, it is possible to put together n periods T to obtain one line period of nT and thus represent a number of gradations by selecting the pulse width in each period T. It is also possible to apply the gradation pulse in two or more frames and thus represent a number of gradations by selecting the application of either of the pulses in FIG. 7B to FIG. 7D in each frame or selecting no application.

### SUMMARY

According to an aspect of the invention, a display device includes a display element of dot matrix type having a display material with memory properties, a drive circuit that drives the pixel of the display element, and a control circuit that controls the drive circuit, wherein the control circuit has an initialization step for bringing about an initialization state by applying a voltage pulse to initialize a pixel to be rewritten and a gradation step for applying a voltage pulse to change the gradation state of the pixel, and in the gradation step, an alternating voltage pulse is formed in the pixel to be rewritten and the period and voltage of the alternating voltage pulse are varied in accordance with a gradation to be written.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1A and FIG. 1B are diagrams explaining a bistable state (planar state and focal conic state) of a cholesteric liquid crystal;

FIG. 2 is a diagram explaining the change in the state of the cholesteric liquid crystal by a pulse voltage;

FIG. 3A and FIG. 3B are diagrams explaining the change in reflectance by a pulse with a large voltage and a wide pulse width to be applied to the cholesteric liquid crystal;

FIG. 4A to FIG. 4D are diagrams explaining the change in reflectance by pulses with an intermediate voltage and two kinds of narrow pulse width to be applied to the cholesteric liquid crystal;

FIG. 5A and FIG. 5B are diagrams illustrating driver output voltages and liquid crystal applied voltages at the time of the application of gradation pulse;

FIG. 6A and FIG. 6B are diagrams illustrating examples of symmetric pulses to be actually applied;

FIG. 7A to FIG. 7D are diagrams illustrating examples of an initialization pulse to be applied to a liquid crystal and three gradation pulses with different pulse widths;

FIG. 8 is a diagram illustrating the response characteristic (reduction in brightness) of a liquid crystal versus the drive energy to be applied to the cholesteric liquid crystal in write processing in an embodiment;

FIG. 9 is a diagram illustrating an example in which the relationship between the gradation and the energy cumulative value is changed in the low gradation;

FIG. 10 is a diagram illustrating the relationship between the input gradation and the output gradation when the display range of the low gradation is enlarged by changing the relationship in the low gradation;

FIG. 11 is a diagram illustrating the change in brightness with respect to the number of applied pulses when the energy of the pulse is maintained constant and the voltage is varied in the high gradation;

FIG. 12 is a diagram illustrating a lamination structure of the cholesteric liquid crystal element of a color display device in an embodiment;

FIG. 13 is a diagram illustrating a structure of one cholesteric liquid crystal element of a color display device in the embodiment;

FIG. 14 is a diagram illustrating a general configuration of the color display device in the embodiment;

FIG. 15 is a diagram illustrating the write operation of a gradation in the embodiment;

FIG. 16A and FIG. 16B are diagrams illustrating the drive output voltage and the applied voltage in a first step (initialization processing) in the embodiment;

FIG. 17A to FIG. 17C are diagrams explaining the entire surface planar reset processing in the first step (initialization processing) in the embodiment;

FIG. 18A and FIG. 18B are diagrams illustrating the driver output voltage and the applied voltage in a second step (write processing) in the embodiment;

FIG. 19A and FIG. 19B are diagrams illustrating the driver output voltage and the applied voltage in the second step (write processing) in the embodiment;

FIG. 20A and FIG. 20B are diagrams illustrating the driver output voltage and the applied voltage in the second step (write processing) in the embodiment;

FIG. 21 is a diagram illustrating gradation pulses Hi to H8 output in a frame F1 in the second step (write processing) in the embodiment in correspondence with the gradation level;

FIG. 22 is a diagram illustrating gradation pulses H1 to H8 output in a frame F2 in the second step (write processing) in the embodiment in correspondence with the gradation level;

FIG. 23 is a diagram illustrating gradation pulses H1 to H8 output in a frame F3 in the second step (write processing) in the embodiment in correspondence with the gradation level;

FIG. 24 is a diagram illustrating a gradation pulse pattern in a modification example in which the second step (write processing) is carried out with one positive/negative pulse in one frame.

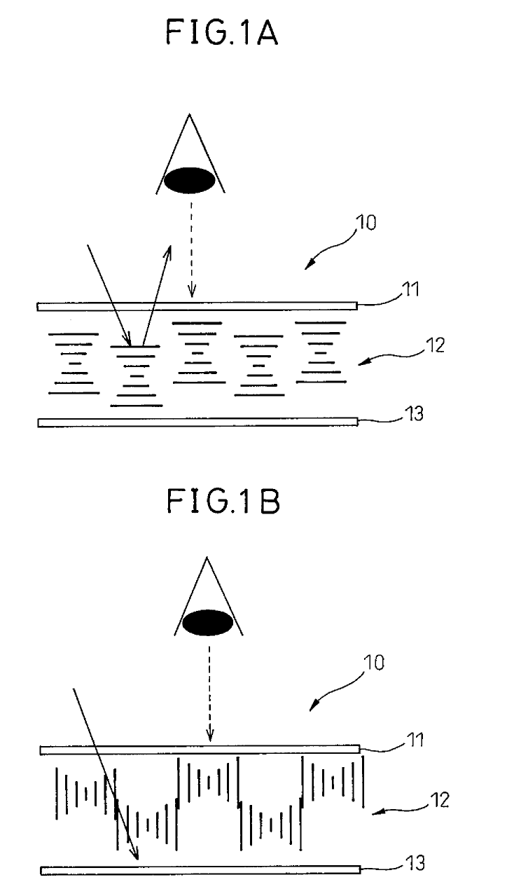

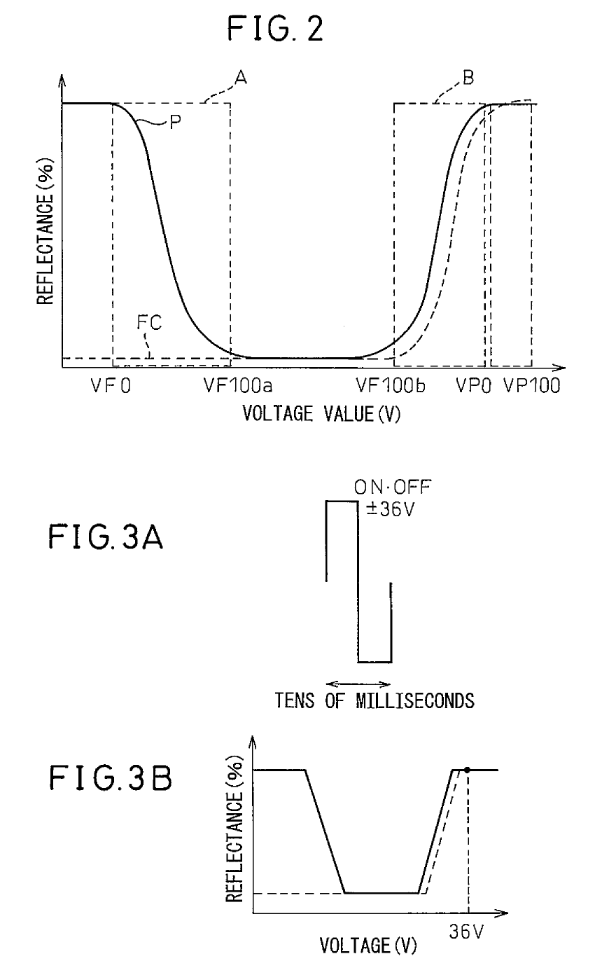

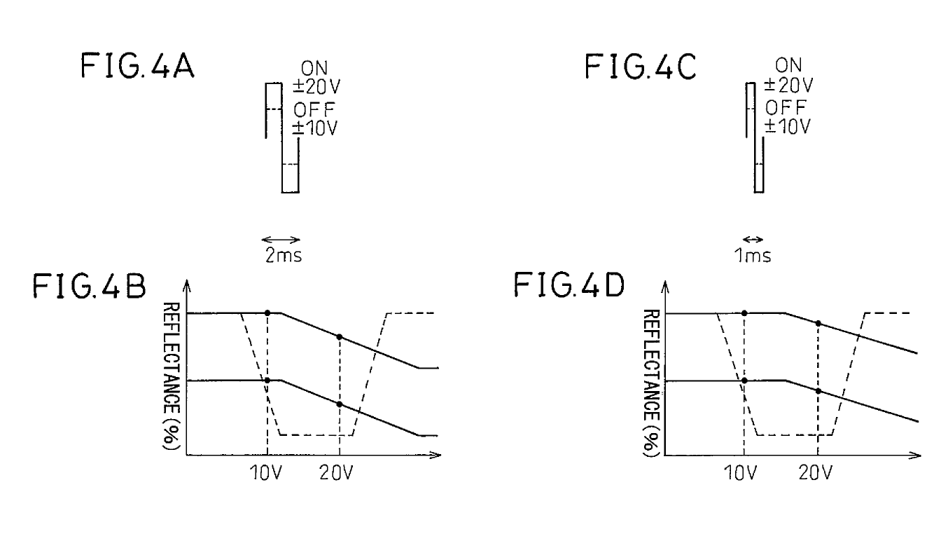

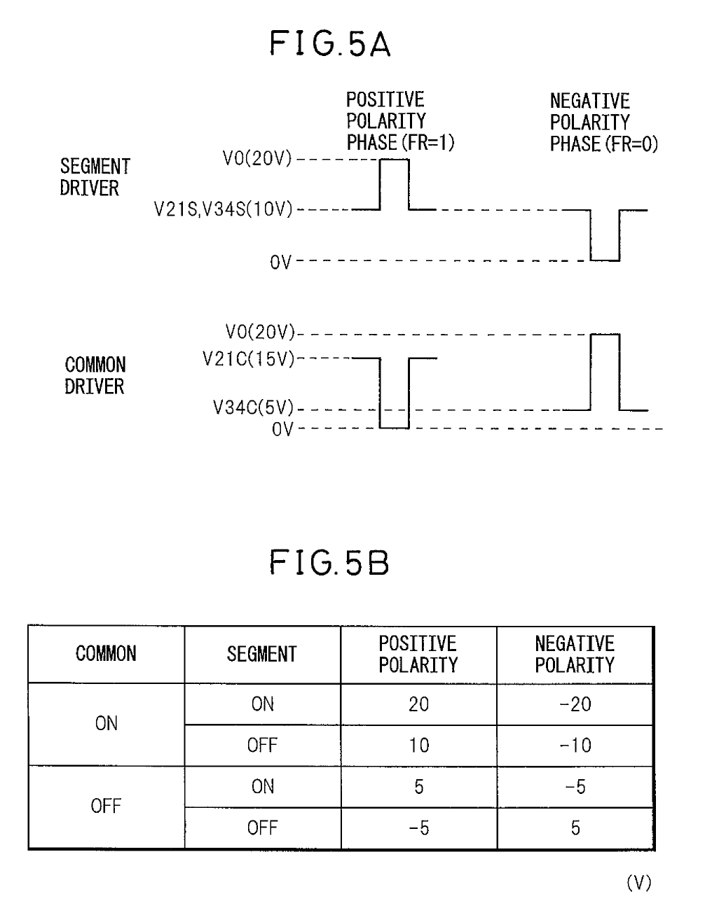

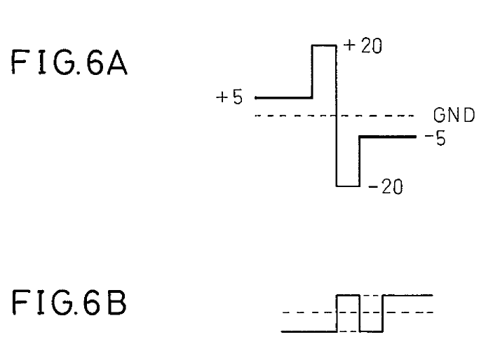

### DESCRIPTION OF EMBODIMENTS

Before describing the embodiments, techniques described in patent applications which were not published before Japanese Patent Application No. 2008-166126, from which the benefit of priority is claimed by this application, and which was filed on Jun. 25, 2008, will be described.

With the conventional drive method, due to the collapse of gradation or skip of gradation, an even gradation is difficult to display. In order to solve this problem, the applicants of the present application filed Japanese Patent Application No. 2007-11523, which was published on Nov. 6, 2008, as Japanese Laid-open Patent Publication (Kokai) No. 2008-268566, describing a drive method in which the display range of the low gradation is widened by increasing the difference in the pulse width cumulative value between neighboring gradations in the low gradation (shadow (dark gradation)) part than in the intermediate gradation (mid tone) part and the high gradation (highlight (bright gradation)) part.

Further, the applicants of the present application filed Japanese Patent Application No. 2008-001957, which was not published yet, describing a drive method by which an even gradation display can be obtained in a wider range by focusing attention on the gradation display characteristics in the high gradation, not only in the low gradation, and further focusing attention on the relationship with the pulse voltage.

The content of the description in Japanese Patent Application No. 2008-001957 is referred to and incorporated herein, along with the content of the description in PCT/JP2007/70093.

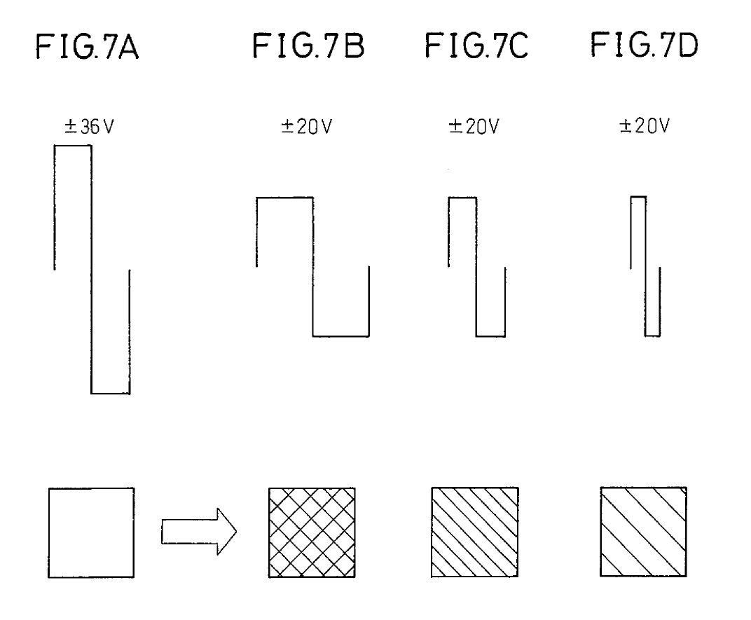

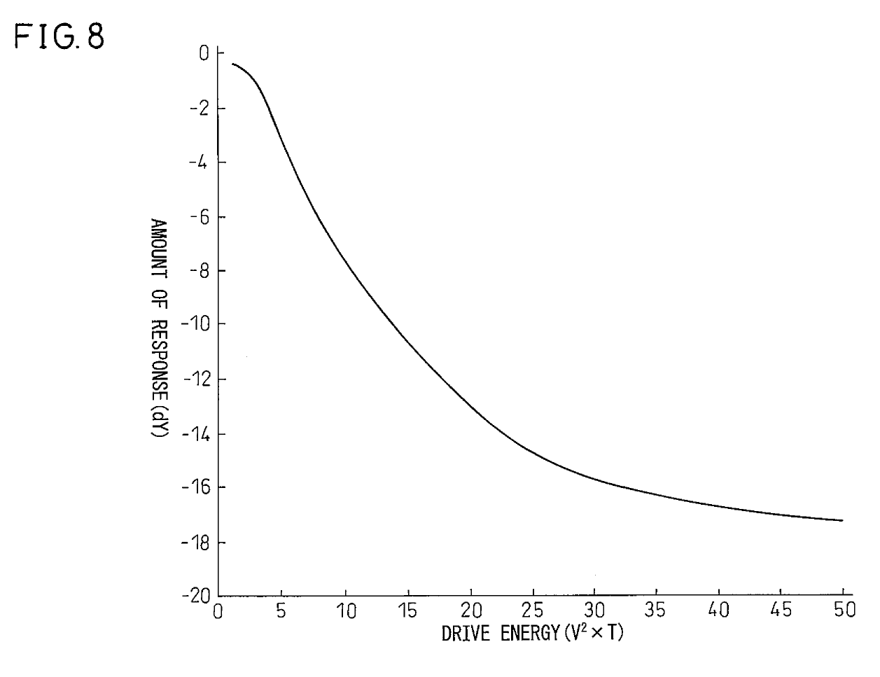

The response characteristic in response of a display element using cholesteric liquid crystal, to the application of energy, is explained with reference to FIG. 8. FIG. 8 is a graph illustrating the change in brightness (reflectance) when a voltage pulse with a voltage of ±20 V is applied after the initialization to bring the liquid crystal into the planar state by carrying out a first step in FIG. 7A in which a voltage pulse with a voltage of ±36 V and a pulse width of tens of milliseconds is applied. In FIG. 8, the horizontal axis represents the drive energy expressed by the product of the squared voltage of the voltage pulse and the pulse width, and the vertical axis represents the amount of response expressed by a change in amount of brightness dY. The drive energy is changed by changing the pulse width of the voltage pulse.

The inventors of the present application have found that the amount of response of the cholesteric liquid crystal has a high correlation with the product V²T of the squared voltage V of the voltage pulse and the pulse width T, that is, the energy as a capacitive load and is different from a general STN liquid crystal that illustrates a correlation with the product VT of the voltage V and the pulse width T. However, as illustrated in FIG. 8, the gradient of the change in the amount of response is smaller in the high gradation part in which the amount of response dY is from 0 to −2 and in the low gradation part in which the amount of response dY is −14 or less, compared to the intermediate gradation part in which the amount of response dY is from −2 to −14. In other words, the energy required to introduce a certain amount of response is relatively larger in the high gradation part and the low gradation part compared to the intermediate gradation part.

The following two reasons are given as reasons why the amount of response is small in the high gradation part.

(1) In the high gradation part, the drive energy is small, and therefore, the liquid crystal molecules cannot escape from the boundary surface binding.

(2) Susceptibility to the influence of the dulled waveform of the voltage pulse due to the CR characteristic of the panel.

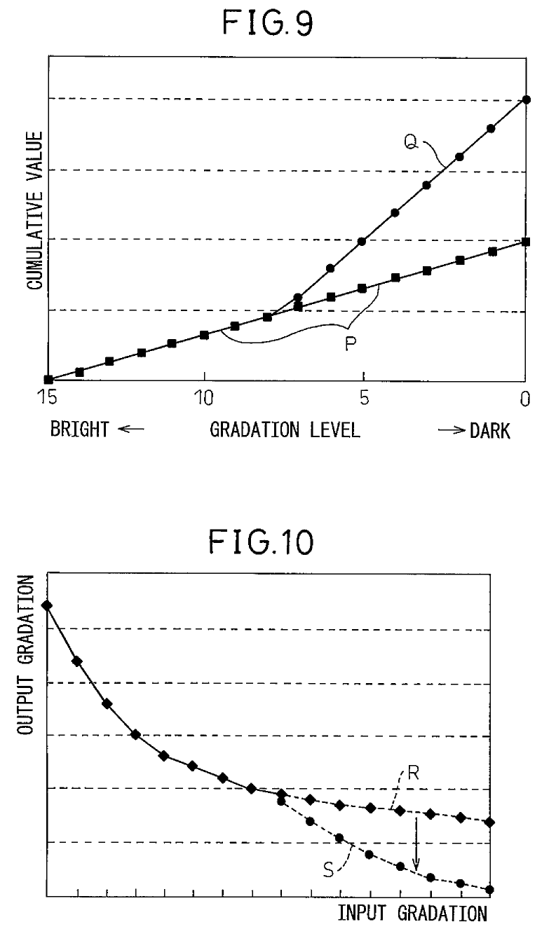

FIG. 9 and FIG. 10 are diagrams explaining that the difference of the energy cumulative value between neighboring gradations in the low gradation part is corrected so as to be larger than that in the intermediate gradation part in order to widen the display range of the low gradation.

FIG. 9 is a diagram illustrating the relationship between the gradation level to be displayed and the cumulative value of the drive energy. In FIG. 9, the line denoted by P illustrates the relationship in which the cumulative value of the drive energy increases in proportion to the gradation level with a first coefficient of proportion. In contrast to this, the line denoted by Q illustrates one in which the coefficient of proportion changes to another from the gradation level in the middle.

FIG. 10 is a diagram illustrating the relationship between the input gradation and the output gradation when the relationship in FIG. 9 is used. In FIG. 10, a line R illustrates the relationship between the input gradation and the output gradation when the relationship illustrated by P in FIG. 9 is used and a line S illustrates the relationship between the input gradation and the output gradation when the relationship illustrated by Q in FIG. 9 is used. As illustrated schematically, it can be seen that the low gradation part of the output gradation extends downward. Thus, effects can be obtained in which the range of the low gradation is widened, the collapse of gradation in the low gradation is reduced, the responsibility in the low gradation is increased, and the contrast is improved. Further, the inventors of the present application have found that it is effective to raise the voltage of the voltage pulse in order to further widen the display range of the low gradation part. When the drive energy of one voltage pulse is made identical, the voltage is raised higher and the pulse width is made narrower than those of the voltage pulse to be applied to the intermediate gradation.

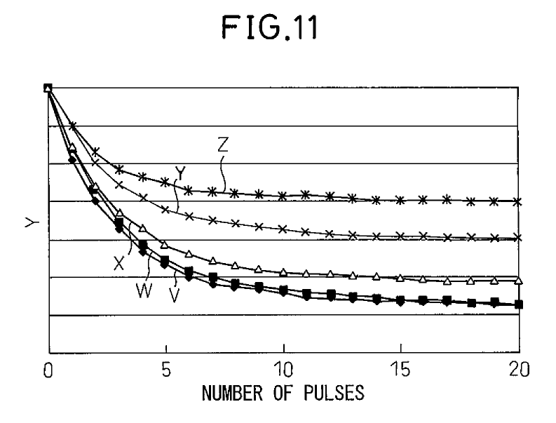

It has also been found that the collapse of gradation occurs for the energy cumulative values from one to four levels in the high gradation part and that the skip of gradation occurs for those from four to six levels. Because of this, a configuration is made so that the intervals between the energy cumulative values corresponding to the gradation is widened in the high gradation part. Further, the inventors of the present specification have found that the change in the cumulative value of energy to be applied to the liquid crystal in the high gradation and the change in brightness (gradation) become close to the linear change by applying a voltage pulse with a relatively lower voltage and a relatively longer period when displaying the high gradation than when displaying the intermediate gradation, and thus, the setting of gradation becomes easier. FIG. 11 is a diagram explaining this.

FIG. 11 illustrates the change in brightness Y in accordance with the number of applied pulses when the product V²T of the squared voltage V of the voltage pulse and the pulse width T is kept constant and the voltage V and the pulse width T are varied. The voltage V and the pulse width T are varied on the basis when the voltage V is ±20 V and the pulse width T is 0.5 ms. Lines V, W, X, Y, and Z illustrate the cases where the voltage V is 16 V, 18 V, 20 V, 22 V, and 24 V, respectively. From FIG. 11, it can be seen that the change in gradation is larger when a voltage pulse with a lower voltage and a wider pulse is applied and thus an advantageous responsibility can be obtained. In other words, in the low gradation part, a pulse with a higher voltage and a shorter width is more advantageous, however, in the high gradation part, a pulse with a lower voltage and a wider width is more advantage.

As described above, it has been found that the larger the difference in the energy cumulative value of the applied voltage pulse between neighboring gradations is made, the more advantageous in terms of gradation representation in the high gradation part and the low gradation part than in the intermediate gradation part, and the application of a pulse with a lower voltage and a wider width in the high gradation part and the application of a pulse with a higher voltage and a narrower width are more advantageous in terms of even gradation representation.

With the display device in the present embodiment, it is possible to carry out even gradation representation with a low power consumption and in a wide range.

Next, an embodiment of a cholesteric liquid crystal display device to which the above-described drive method has been applied, is explained. The cholesteric liquid crystal display device is explained.

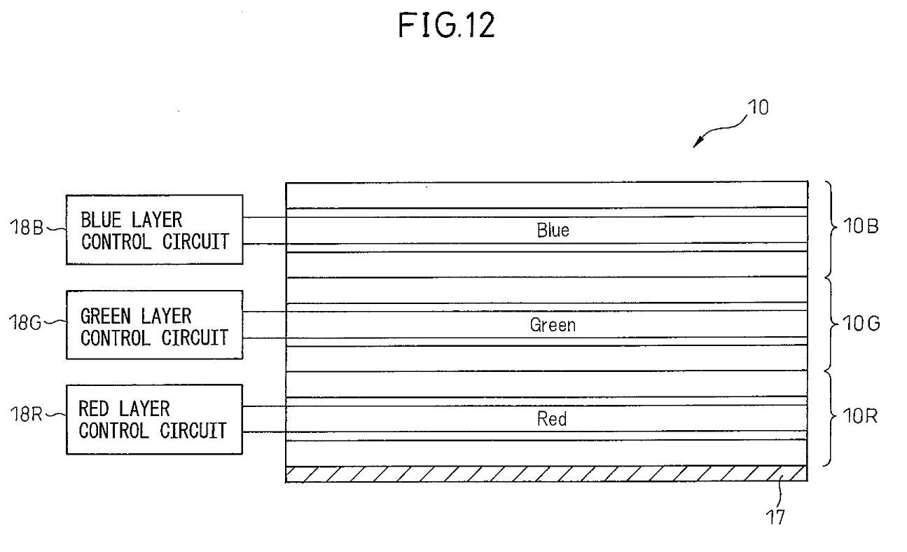

FIG. 12 is a diagram illustrating a configuration of a display element 10 used in the embodiment. As illustrated in FIG. 12, in display element 10, three panels are laminated, that is, a blue panel 10B, a green panel 10G, and a red panel 10R in this order from the viewing side, and under red panel 10R, a light absorption layer 17 is provided. Panels 10B, 10G, and 10R have the same configuration; however, liquid crystal materials and chiral materials are selected and the containment percentage of the chiral material is determined so that the center wavelength of reflection of panel 10B is blue (about 480 nm), the center wavelength of reflection of panel 10G is green (about 550 nm), and the center wavelength of reflection of panel 10R is red (about 630 nm). Panels 10B, 10G, and 10R are driven by a blue layer control circuit 18B, a green layer control circuit 18G, and a red layer control circuit 18R, respectively.

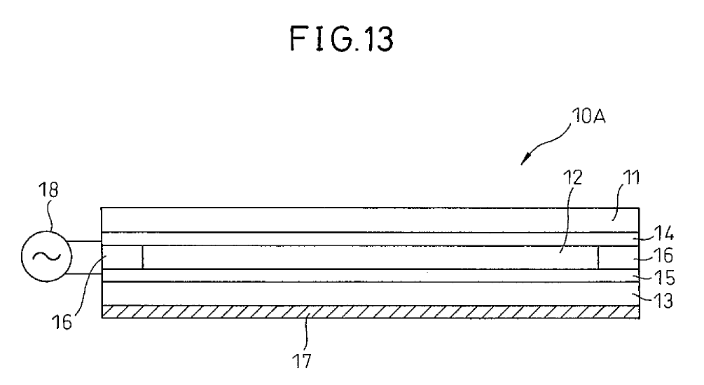

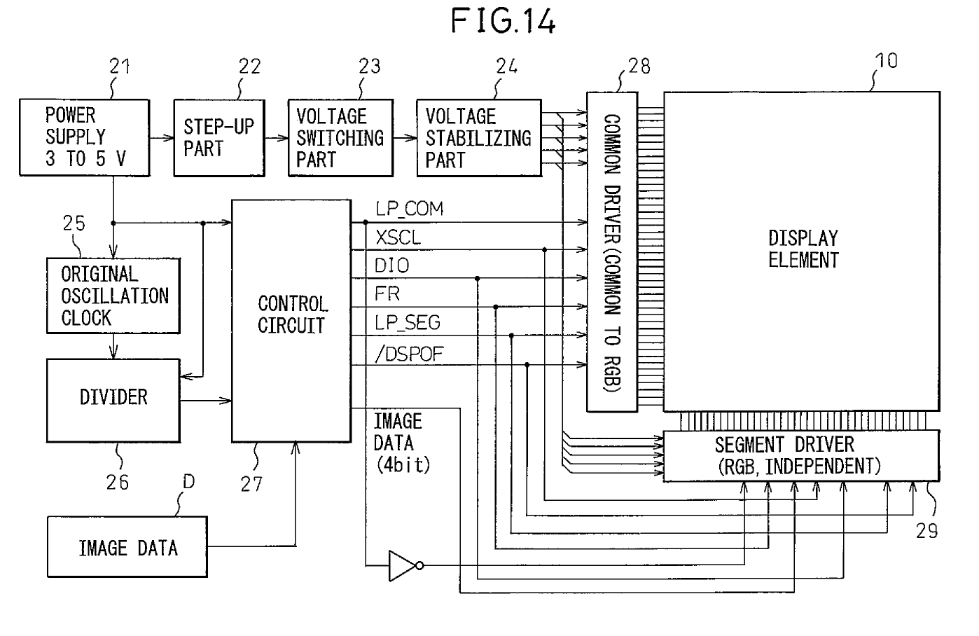

FIG. 13 is a diagram illustrating a basic configuration of a panel 10A, which is one of three panels 10B, 10G, and 10R that constitute display element 10 in FIG. 14. Three panels 10B, 10G, and 10R have a substantially common configuration except for the reflection wavelengths. The panel used in the embodiment is explained with reference to FIG. 13.

As illustrated in FIG. 13, display element 10A has an upper side substrate 11, an upper side electrode layer 14 provided on the surface of upper side substrate 11, a lower side electrode layer 15 provided on the surface of a lower side substrate 13, and a sealing material 16. Upper side substrate 11 and lower side substrate 13 are arranged to that the electrodes oppose each other and sealed by sealing material 16 after a liquid crystal material is sealed in between them. A spacer is arranged in a liquid crystal layer 12, however, its schematic representation is omitted. To the electrodes of upper side electrode layer 14 and lower side electrode layer 15, a voltage pulse signal is applied from a drive circuit 18 and thereby a voltage is applied to liquid crystal layer 12. A display is produced by applying a voltage to liquid crystal layer 12 to bring the liquid crystal molecules of liquid crystal layer 12 into the planar state or the focal conic state.

Although both upper side substrate 11 and lower side substrate 13 have transparency, lower side substrate 13 of panel 10R may be opaque. As a substrate that has transparency, there is a glass substrate, however, a film substrate made of polyethylene terephthalate (PET) or polycarbonate (PC) may be used besides the glass substrate.

As a material of the electrodes of upper side electrode layer 14 and lower side electrode layer 15, for example, indium tin oxide (ITO) is typical, however, a transparent conductive film made of indium zinc oxide (IZO) may also be used.

The transparent electrode of upper side electrode layer 14 is formed as a plurality of band-like upper side transparent electrodes parallel to each another on upper side substrate 11 and the transparent electrode of lower side electrode layer 15 is formed as a plurality of band-like lower transparent electrodes parallel to each another on lower side substrate 13. Then, upper side substrate 11 and lower side substrate 13 are arranged so that the upper side electrode and the lower side electrode intersect when viewed from the direction perpendicular to the substrate and a pixel is formed at the intersection. An insulating thin film is formed on the electrode. If the thin film is thick, the drive voltage needs to be raised and it becomes difficult to configure a drive circuit using a general-purpose driver for STN etc. Conversely, if no thin film exists, leak current increases, and therefore, power consumption increases arises. The thin film has a relative dielectric constant of about 5, which is considerably lower than that of the liquid crystal, and therefore, it is suitable to set the thickness of the thin film to about 0.3 μm or less.

The insulating thin film can be realized by a thin film of SiO₂, or an organic film, such as one made of polyimide resin or acryl resin, which is known as an orientation-stabilized film.

As described above, a space is arranged in liquid crystal layer 12 and the distance between upper side substrate 11 and lower side substrate 13, that is the thickness of liquid crystal layer 12 is made constant. The spacer is a spherical body made of, in general, resin or inorganic oxide; however, it is also possible to use a fixed spacer coated with thermoplastic resin on the surface of the substrate. The cell gap formed by this spacer is suitable when it is in a range of 3.5 μm to 6 μm. If the cell gap is less than the value, the reflectance is reduced and a dark display is produced, and conversely, if the cell gap is larger than the value, the drive voltage is raised and it becomes difficult to drive with a general-purpose driver.

The liquid crystal composition that forms liquid crystal layer 12 is a cholesteric liquid crystal, which is a nematic liquid crystal mixture to which a chiral material of 10 to 40 wt % is added. The amount of chiral material to be added is the value when the total amount of the nematic liquid crystal component and the chiral material is assumed to be 100 wt %.

As a nematic liquid crystal, those which have been publicly known conventionally can be used, however, it is desirable that the nematic liquid crystal be a liquid crystal material the dielectric constant anisotropy (Δε) of which is in a range of 15 to 35. If the dielectric constant anisotropy is 15 or more, the drive voltage becomes comparatively lower and if beyond the range, the drive voltage itself is lowered; however, the specific resistance is reduced and in particular, the power consumption at high temperatures increases.

It is desirable that the refractive index anisotropy (Δn) be between 0.18 and 0.24. If the refractive index anisotropy is smaller than this range, the reflectance in the planar state is reduced and if larger than the range, in addition to that the scattering reflection in the focal conic state is increased, the viscosity is raised and the response rate is reduced.

FIG. 14 is a diagram illustrating the entire configuration of the display device in the embodiment. Display element 10 has the specification of A4 size XGA and has 1,024×768 pixels. A power source 21 outputs, for example, a voltage of 3 V to 5 V. A step-up part 22 steps up the input voltage from power source 21 to 36 V to 40 V using a regulator, such as a DC-DC converter. For the step-up regulator, a dedicated IC is widely used and the IC has a function to adjust the step-up voltage by setting a feedback voltage. Consequently, it is possible to vary the step-up voltage by selecting a plurality of voltages generated by voltage dividing with a resistor etc. and supplying it to the feedback terminal.

A voltage switching part 23 generates various voltages by resistance division, etc. In order to switch between the reset voltage and the gradation write voltage in voltage switching part 23, an analog switch of high-voltage withstanding type may be used; however, it is also possible to use a simple switching circuit with transistors. It is desirable that a voltage stabilizing part 24 use a voltage follower circuit of an operational amplifier in order to stabilize the various voltages supplied from voltage switching part 23. It is desirable to use an operational amplifier that has a strong property against a capacitive load. A configuration is widely known, in which the amplification factor is switched to another by switching the resistors connected to the operational amplifier and if this configuration is used, it is possible to easily switch the voltage output from voltage stabilizing part 24 to another.

An original oscillation clock part 25 generates a basic clock that serves as a base of the operation. A divider 26 divides the basic clock and generates various clocks necessary for the operations, to be described later.

A control circuit 27 generates a control signal based on the basic clock, the various clocks, and image data D and supplies it to a common driver 28 and a segment driver 29.

Common driver 28 drives 768 scan lines and segment driver 29 drives 1,024 data lines. Because image data given to each pixel of RGB is different from pixel to pixel, segment driver 29 drives each data line independently. Common driver 28 drives RGB lines commonly. In the present embodiment, as driver IC, a general-purpose STN driver of two-value output type is used. As driver ICs available, various ones can be used.

Image data to be input to segment driver 29 is four-bit data D0-D3, which is an original image of full-color converted into data of 4,096 colors with 16 gradations for each of RGB by the error diffusion method. For the gradation conversion, a method by which a high display quality can be obtained is preferred and in addition to the error diffusion method, a blue noise mask method etc. can be used. It is also possible to carry out image quality improvement processing, such as contrast enhancement processing, before and after the gradation conversion.

Next, the image write operation in the embodiment is explained.

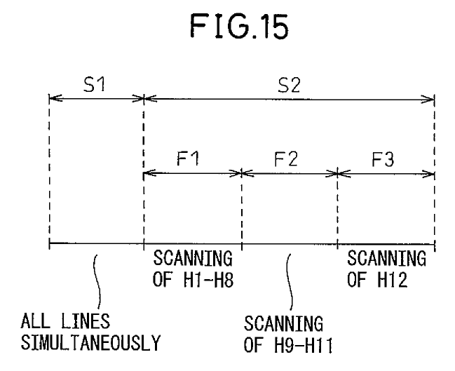

FIG. 15 is a diagram illustrating the image write operation. The image write operation has first step S1 in which a pulse with a voltage of ±36 V and a period of 100 ms is applied simultaneously to all of the pixels and thus all of the pixels are reset to the planar state, and second step S2 in which a gradation pulse of PWM is applied selectively to the pixel after first step S1, and an intermediate state is brought about in which the planar state and the focal conic state coexist mixedly. Second step S2 has three frames, i.e., frames F1, F2, and F3 and in frames F1, F2, and F3, first to third sub-steps are carried out. As will be described later, in frame F1, the application of gradation pulses H1-H8 to each scan line is carried out sequentially and when the application to all of the lines is completed, frame F1 is ended. In frame F2, the application of gradation pulses H9-H11 to each scan line is carried out sequentially and when the application to all of the lines is completed, frame F2 is ended. In frame F3, the application of a gradation pulse H12 to each scan line is carried out sequentially.

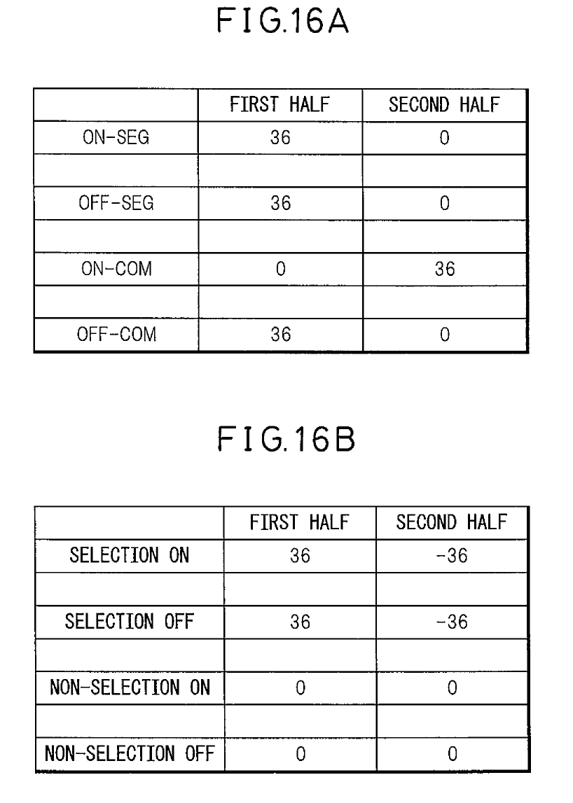

FIG. 16A illustrates the ON and OFF output voltages of common driver 28 and segment driver 29 at the time of reset processing in first step S1. FIG. 16B illustrates the voltages to be applied to the pixel at the time of reset processing when common driver 28 and segment driver 29 output such voltages as illustrated in FIG. 11A.

As illustrated in FIG. 16A, the voltages are switched as illustrated schematically between the first half during which a pulse of positive polarity is applied (positive polarity phase) and the second half during which a pulse of negative polarity is applied (negative polarity phase). In the first half, the ON output voltage (ON-SEG) and the OFF output voltage (OFF-SEG) of segment driver 29 are 36 V, the ON output voltage (ON-COM) of common driver 28 is 0 V, and the OFF output voltage (OFF-COM) of common driver 28 is 36 V. In the second half, the ON and OFF output voltages of segment driver 29 are 0 V, the ON output voltage of common driver 28 is 36 V, and the OFF output voltage of common driver 28 is 0 V.

In FIG. 16B, to the selection ON pixel, the ON output voltage is applied from common driver 28 to select it, the pixel to which the ON output voltage is applied from segment driver 29 is illustrated, and in the first half, 36 V is applied and in the second half, −36 V is applied. To the selection OFF pixel, the ON output voltage is applied form common driver 28 to select it, the pixel to which the OFF output voltage is applied from segment driver 29 is illustrated, and in the first half, 36 V is applied and in the second half, −36 V is applied. To the non-selection ON pixel, the OFF output voltage is applied from common driver 28, the pixel to which the ON output voltage is applied from segment driver 29 is illustrated, and 0 V is applied in the first and second halves. To the non-selection OFF pixel, the OFF output voltage is applied from common driver 28, the pixel to which the OFF output voltage is applied from segment driver 29 is illustrated, and 0 V is applied in the first and second halves.

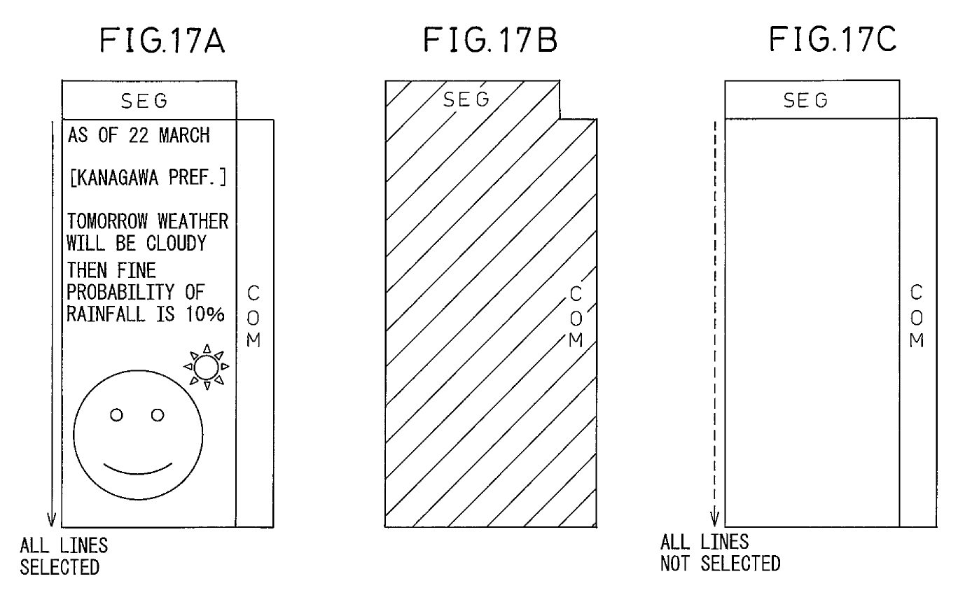

FIG. 17A to FIG. 17C are diagrams for explaining the outline of the reset processing.

First, there is an already written display as illustrated in FIG. 17A. For this, after all of the output voltages of segment driver 29 are set to the ground (GND) level, all of the output lines of common driver 28 are brought into the selection state. It is preferred to set all of the output voltages to the GND level by asserting the voltage OFF function (/DSPOF) owned by the STN driver etc.

Next, when this /DSPOF is negated, ±36 V is applied to all of the selected lines and all of the pixels enter the homeotropic state as illustrated in FIG. 17B.

Next, the voltage applied to all of the selected lines is reverted from +36 V to −36 V. This reversion may be done by reverting the polarity signal (FR) of the general-purpose driver. There can be various voltage setting values of common driver 28 and segment drive 29 for this processing; however, the voltage setting as illustrated in FIG. 16A is preferable because ±36 V can be applied to all of the pixels irrespective of the output value from segment driver 29.

Although the appropriate value of the application time of +36 V and −36 V in this case differs depending on the configuration of the display element, in the embodiment, a pulse with a pulse width of several milliseconds to tens of milliseconds is adopted.

Finally, when −36 V is changed to 0 V, all of the pixels switch from the homeotropic state into the planar state and enter the white state as illustrated in FIG. 17C. For the switching from −36 V to 0 V, it is preferable to use /DSPOF owned by the above-described general-purpose driver. If this /DSPOF is used, discharge is forcedly caused to occur in the short-circuit of the driver IC, and therefore, the discharge time of the charged display element can be shortened. Because the transition into the planar state requires the steepness of the voltage pulse, it is possible for the forced discharge using this /DSPOF to reset without fail to the planar state even if the display element has a large size.

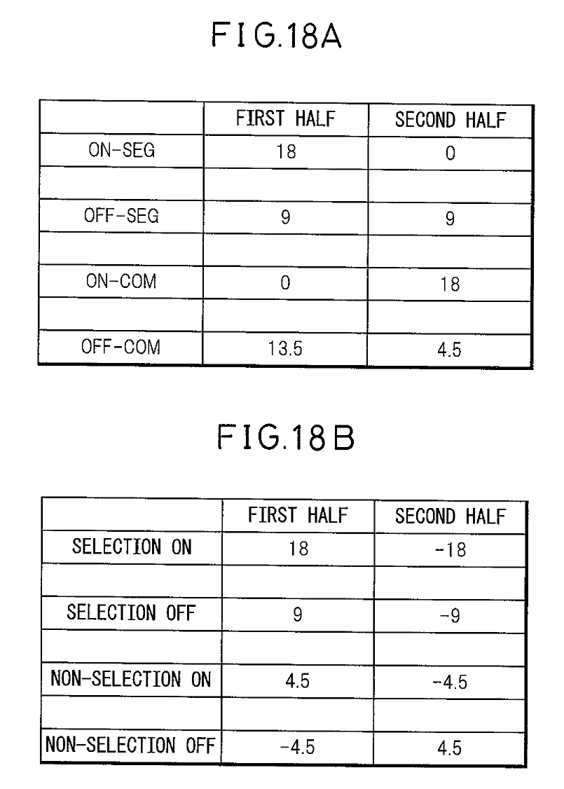

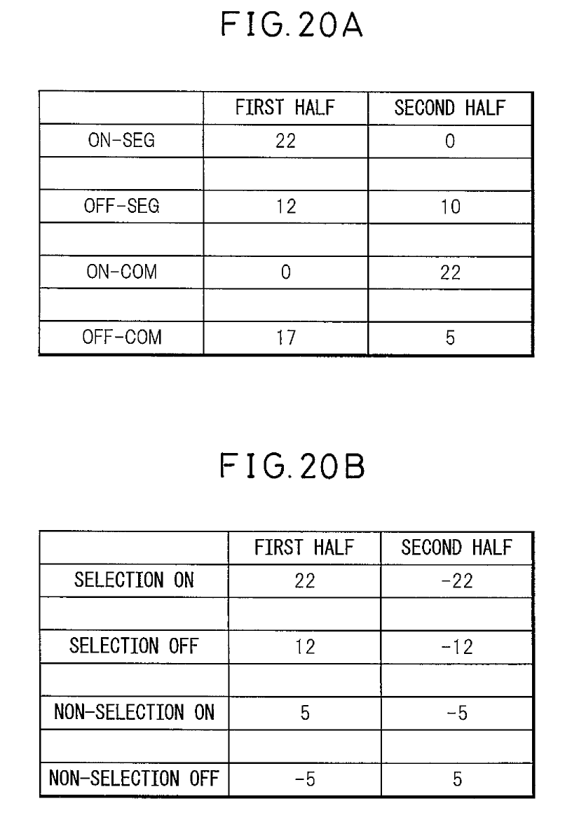

FIG. 18A to FIG. 20B illustrate the ON and OFF output voltages of common driver 28 and segment driver 29 in second step S2 and the voltages applied to the pixel by the output voltages. The relationship between the output voltage and the applied voltage is the same as that explained in FIG. 16A and FIG. 16B, and therefore, its detailed explanation is omitted, however, there exist three kinds of applied voltage pattern and voltage pulses with ±18 V, ±20 V, and ±22 V can be applied to the selection ON pixels.

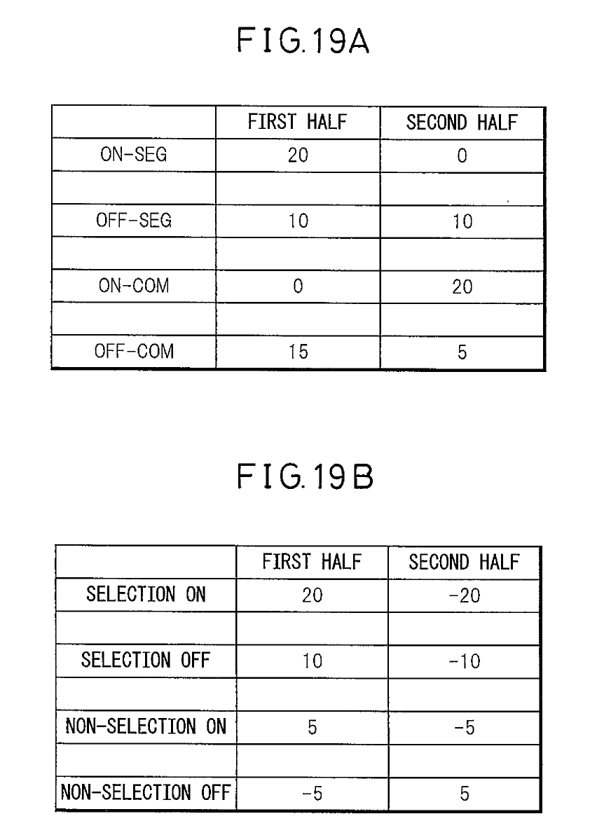

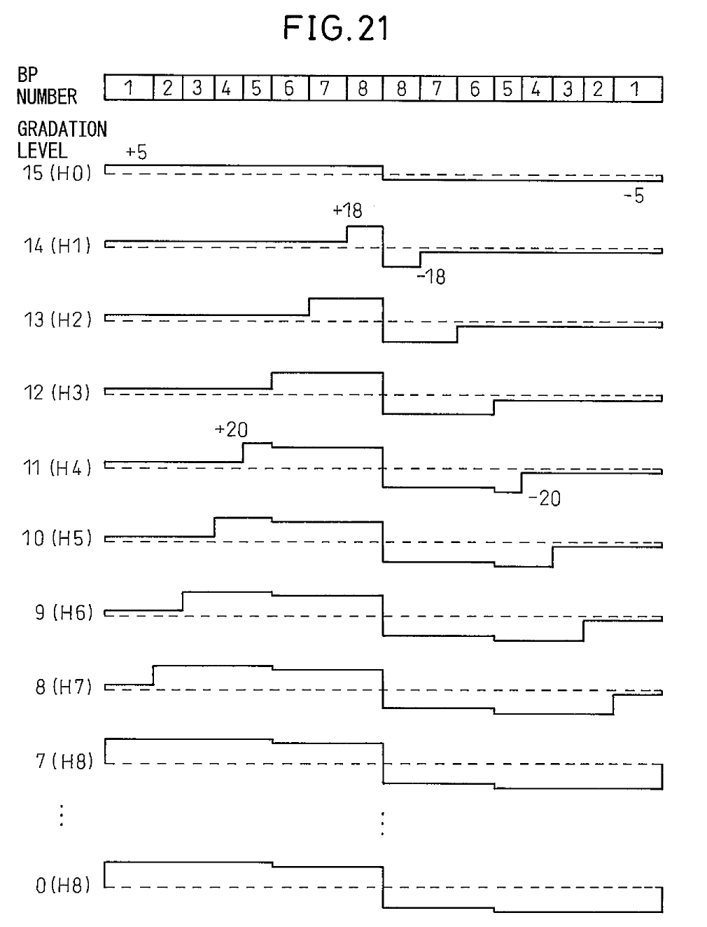

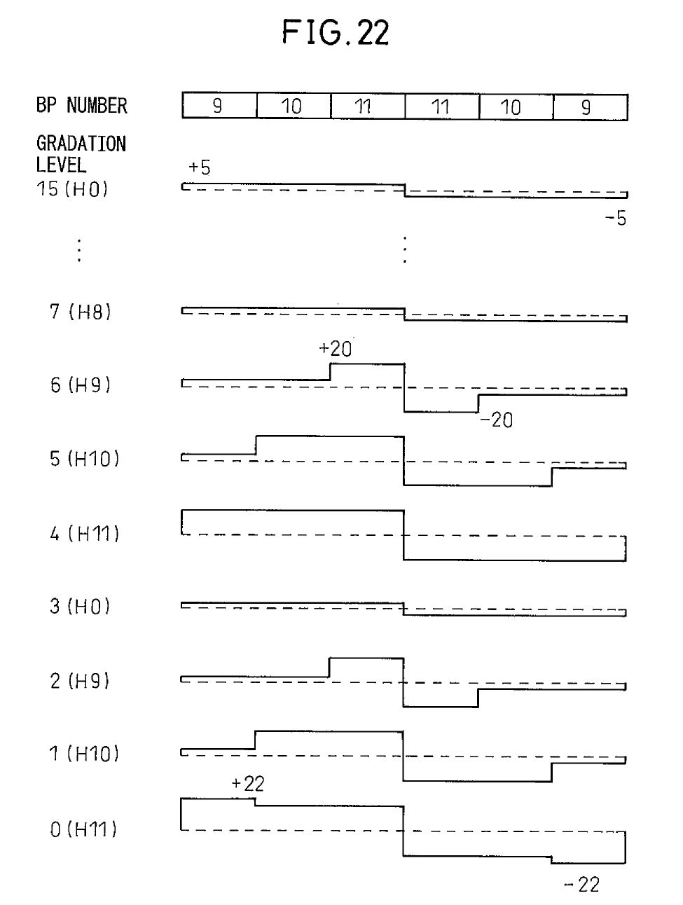

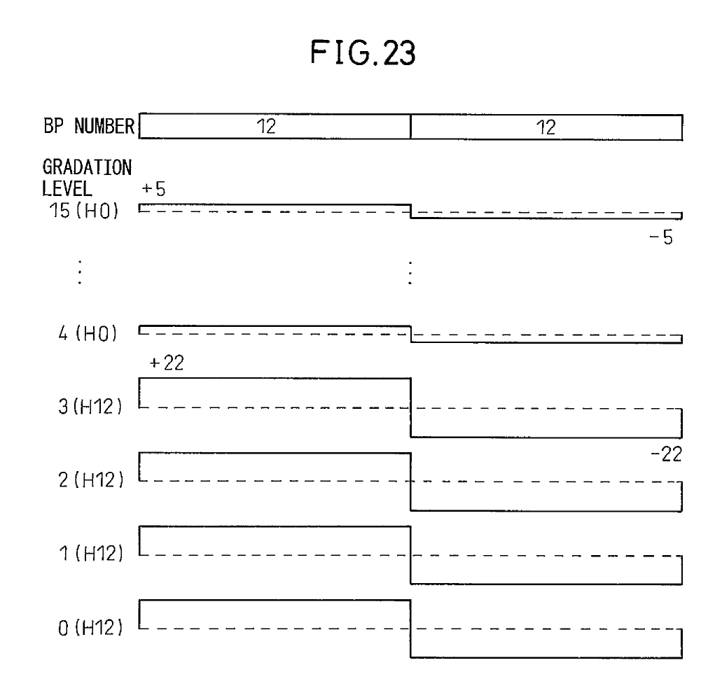

FIG. 21 to FIG. 23 are diagrams illustrating the gradation pulses in second step S2 in the embodiment, wherein FIG. 21 illustrates gradation pulses H1-H8 in frame F1, FIG. 22 illustrates gradation pulses H9-H11 in frame F2, and FIG. 23 illustrates gradation pulse H12 in frame F3. By appropriately selecting the applied voltage illustrated in FIG. 18A to FIG. 19B in each bit plane BP, it is possible to generate the successive gradation pulses as illustrated in FIG. 21 to FIG. 23. The pulse of ±5 V in the half-selection state is expressed by H0. Each gradation level receives a voltage pulse in which the gradation patterns in frames F1 to F3 are accumulated and changes into a corresponding gradation level from the initialization state.

As illustrated in FIG. 21 to FIG. 23, in the gradation patterns in frames F1 to F3, the positive polarity phase and the negative polarity phase of each gradation pulse are made successive and each frame has one position/negative pulse. Due to this, the power consumption accompanying the switching of output voltages of the driver IC can be reduced, and therefore, power consumption can be reduced.

Further, for the gradation patterns in frames F1 to F3, there are three kinds of voltage to be applied to the selection ON pixel (±18 V, ±20V, ±22 V) and the lengths of bit plane BP (pulse period of the gradation pulse) are different. For example, the gradation pulse of bit planes BP 2 to 5 in frame F1 is the reference, which has a short period and is a pulse with an intermediate voltage (±20 V). In contrast to this, in bit planes BP 6 to 8 in frame F1, the pulse has a comparatively long period (for example, 1.4 times that of BPs 2 to 5) and is a pulse with a comparatively low voltage (±18 V). In bit plane BP1 in frame F1, the pulse has a long period (for example, twice the period of BPs 2 to 5) and is a pulse with an intermediate voltage (±20 V). In bit planes 10, 11 in frame F2, the pulse has a further longer period (for example, three times the period of BPs 2 to 5) and is a pulse with an intermediate voltage (±20 V), and in bit plane BP 9 in frame F2, the pulse has a long period (the same period as that of BPs 10, 11) and is a pulse with a comparatively high voltage (±22 V). In bit plane BP 12 in frame F3, the pulse has a further longer period (for example, ten times the period of BPs 2 to 5) and is a pulse with a comparatively high voltage (±22 V).

As described above, for the amount of response of the cholesteric liquid crystal, based on the high correlation with the product V²T of the squared voltage V of the voltage pulse and the pulse width T, i.e., the energy of the capacitive load, the voltage and period of each bit plane are set so that each gradation level and the energy correspond to such a correlation by applying a voltage using frames F1 to F3 of the bit planes. Further, in the embodiment, the gradation energy difference in the low gradation far from the initialization gradation and the gradation energy difference in the high gradation near to the initialization gradation are adjusted so as to be larger than the gradation energy difference in the intermediate gradation, where the gradation energy difference is a difference between the application energy of the voltage pulse to be applied to the liquid crystal in the initial gradation in order to display a given gradation and the application energy of the voltage pulse to be applied in order to display another gradation different by one gradation. In addition, at gradation levels 12 to 14 of the high gradation, a gradation pulse with a voltage of ±18 V, that is, a comparatively low voltage, and a long period is applied. At gradation levels 0 to 3 of the low gradation, gradation pulses with a low voltage and an intermediate voltage are also applied; however, most of the energy to be applied is applied by the gradation pulse with a high voltage (±22 V). Due to this, in the low gradation part and the high gradation part, the energy difference between neighboring gradations is larger than that in the intermediate gradation part, and in the high gradation part, a gradation pulse with a low voltage and a relatively long period is applied and in the low gradation part, a gradation pulse with a high voltage and a relatively short period is applied, and therefore, the evenness of gradation is improved as explained with reference to FIG. 8 to FIG. 22.

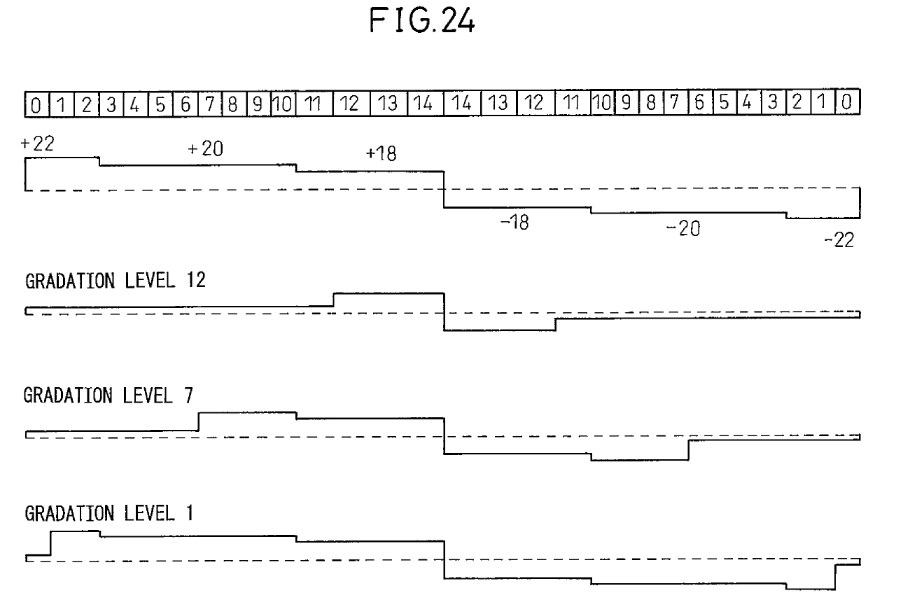

In the above-described embodiment, step S2 is configured by three frames F1 to F3, however, it is also possible to configure step S2 by one frame as illustrated in FIG. 24. In an example illustrated in FIG. 24, a voltage pulse pattern in which the gradation pulses are successive so that the voltage changes +22 V, +20 V, +18 V, −18 V, −20 V, and −22 V in this order is applied during the scanning of one line. In order to change the gradation into a desired gradation, the pulse in the range corresponding to the gradation and higher are turned on during the pulse terms illustrated at the uppermost part and thus the voltage pulse is applied. The case where none is turned on corresponds to gradation level 15. For example, when gradation level 12 is written, the pulse is turned on during pulse terms 12 to 14 as illustrated schematically. Due to this, a voltage pulse with a voltage of ±18 is applied during the pulse terms illustrated by 12 to 14. Similarly, when gradation level 7 is written, the pulses are turned on during pulse terms 7 to 14 as illustrated schematically and when gradation level 1 is written, the pulses are turned on during pulse terms 1 to 14 as illustrated schematically.

The length of each pulse term is set so that it changes based on each gradation level and the product V²T of the squared voltage V of the voltage pulse and the pulse width T and further, the gradation energy difference in the low gradation and the high gradation is larger than the gradation energy difference in the intermediate gradation. On the basis of the pulse terms 3 to 10, at gradation levels 11 to 14 in the high gradation, the voltage is ±18 V, a comparatively low voltage, as illustrated in FIG. 24, and therefore, the pulse terms 11 to 14 are made comparatively longer in order to meet the above-mentioned condition, and at gradation levels 0 to 2 in the low gradation, the voltage is ±22 V, a comparatively high voltage, and therefore, the pulse terms 0 to 2 are made comparatively shorter in order to meet the above-mentioned condition. At gradation levels 0 to 3 in the low gradation, gradation pulses with a low voltage and with an intermediate voltage are also applied, however, a gradation pulse with a high voltage (±22 V) that is not applied at other gradation levels is applied.

Although the embodiments of the present invention are described as above, it is obvious that there can be other various embodiments. For example, the present invention can be applied to a display element of dot matrix type having the memory properties in addition to the display element that uses the cholesteric liquid crystal.

The setting of the pulse width of the gradation pulse and the setting of the cumulative value in sub-steps in the second step should be determined in accordance with the specifications of the targeted display element.

All examples and conditional language recited herein are intended for pedagogical purposes to aid the reader in understanding the invention and the concepts contributed by the invention to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alternations could be made hereto without departing from the spirit and scope of the invention.

What is claimed is:

1. A display device comprising:
a display element of dot matrix type including a display material with memory properties;
a drive circuit that drives a pixel of the display element; and
a control circuit that controls the drive circuit, wherein
the control circuit carries out an initialization step to apply a voltage pulse to initialize a pixel to be rewritten to bring the pixel into an initialization state, and a gradation step to apply a voltage pulse to change the gradation state of the pixel; and
in the gradation step, an alternating voltage pulse is formed in the pixel to be rewritten and the period and voltage of the alternating voltage pulse are varied in accordance with a gradation to be written.

2. The display device according to claim 1, wherein
the gradation step includes a plurality of sub-steps having a plurality of execution times and in at least one of the plurality of sub-steps, an alternating voltage pulse is formed in a pixel to be rewritten and the period and voltage of the alternating voltage pulse are varied in accordance with a gradation to be written.

3. The display device according to claim 1, wherein
in the gradation step, the initial gradation is changed to the high gradation, the intermediate gradation, and the low gradation; and
the gradation energy difference in the low gradation far from the initialization gradation is larger than the gradation energy difference in the intermediate gradation in the gradation step, where the gradation energy difference is a difference between the application energy of the voltage pulse to be applied to the liquid crystal in the initial gradation in order to display a given gradation and the application energy of the voltage pulse to be applied in order to display another gradation different by one gradation.

4. The display device according to claim 3, wherein
the gradation energy difference in the high gradation near to the initialization gradation is larger than the gradation energy difference in the intermediate gradation in the gradation step.

5. The display device according to claim 4, wherein
when the low gradation is written in the gradation step, the alternating voltage pulse with a relatively higher voltage than when the intermediate gradation is written is applied.

6. The display device according to claim 4, wherein
when the high gradation is written in the gradation step, the alternating voltage pulse with a relatively lower voltage than when the intermediate gradation is written is applied.

7. The display device according to claim 6, wherein
the application energy is calculated from the voltage value and pulse period of the voltage pulse.

8. The display device according to claim 7, wherein
the application energy is expressed by the product of the squared voltage value of the voltage pulse and the pulse period.

9. The display device according to claim 1, wherein
the display material is a liquid crystal that forms a cholesteric phase.

10. The display device according to claim 9, wherein
the initialization state in the initialization step is a planar state, the gradation state in the gradation step is a state where the planar state and a focal conic state coexist mixedly, and the value of an intermediate gradation is determined from the mixing ratio.

11. A drive method of a display element of dot matrix type including a display material with memory properties, comprising:
an initialization step for applying a voltage pulse to initialize a pixel to be rewritten to bring the pixel into an initialization state; and
a gradation step for applying a voltage pulse to change the gradation state of a pixel, wherein
in the gradation step, an alternating voltage pulse is formed in a pixel to be rewritten and the period and voltage of the alternating voltage pulse are varied in accordance with a gradation to be written.

12. The drive method according to claim 11, wherein
the gradation step includes a plurality of sub-steps having a plurality of execution times and in at least one of the plurality of sub-steps, an alternating voltage pulse is formed in a pixel to be rewritten and the period and voltage of the alternating voltage pulse are varied in accordance with a gradation to be written

13. The drive method according to claim 12, wherein
in the gradation step, the initial gradation is changed to the high gradation, the intermediate gradation, and the low gradation; and
the gradation energy difference in the low gradation far from the initialization gradation is larger than the gradation energy difference in the intermediate gradation in the gradation step, where the gradation energy difference is a difference between the application energy of the voltage pulse to be applied to the liquid crystal in the initial gradation in order to display a given gradation and the application energy of the voltage pulse to be applied in order to display another gradation different by one gradation.

14. The drive method according to claim 13, wherein
the gradation energy difference in the high gradation near to the initialization gradation is larger than the gradation energy difference in the intermediate gradation in the gradation step.

15. The drive method according to claim 14, wherein
when the low gradation is written in the gradation step, the alternating voltage pulse with a relatively higher voltage than when the intermediate gradation is written is applied.

16. The drive method according to claim 14, wherein
when the high gradation is written in the gradation step, the alternating voltage pulse with a relatively lower voltage than when the intermediate gradation is written is applied.

17. The drive method according to claim 16, wherein
the application energy is calculated from the voltage value and pulse period of the voltage pulse.

18. The drive method according to claim 17, wherein
the application energy is expressed by the product of the squared voltage value of the voltage pulse and the pulse period.

19. The display device according to claim 11, wherein
the display material is a liquid crystal that forms a cholesteric phase.

20. The display device according to claim 19, wherein
the initialization state in the initialization step is a planar state, the gradation state in the gradation step is a state where the planar state and a focal conic state coexist mixedly, and the value of an intermediate gradation is determined from the mixing ratio.
